(19) United States
(12) Patent Application Publication
(10) Pub. No.: US 2010/0208022 A1
(43) Pub. Date: Aug. 19, 2010

(54) SYSTEM FOR THE FIXING OF PRINTED IMAGES ON A PRINTING SUBSTRATE

(76) Inventors: Michael Pohlt, Muenchen (DE); Thomas Schwarzenbeck, Poing (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/706,027

(22) Filed: Feb. 16, 2010

(30) Foreign Application Priority Data
Feb. 16, 2009 (DE) 10 2009 009 043.6

(51) Int. Cl. B41J 2/01; G03G 15/20

(52) U.S. Cl. 347/102; 399/310

(57) ABSTRACT

Printed images exhibiting a color medium are applied to the printing substrate by a printing device, the printing substrate having been provided beforehand with a viscous fluid film by an application unit arranged in front of the printing device. The color medium of the printed images migrates to a surface of the viscous fluid film and adheres there. After the drying of the fluid film the printed images are firmly fixed on the printing substrate.

### BACKGROUND

For the imprinting of a printing substrate e.g. of a single sheet or of a web-like printing substrate of the most variable materials, such as e.g. paper or thin plastic or metal films it is known to produce image-dependent charge images on a charge image carrier, e.g. a photo conductor, the charge images corresponding to the images to be printed, comprised of regions to be inked and regions not to be inked. The regions of the charge images to be inked are developed with a developer station by a color medium, e.g. toner or color particles. Then the developed images are reprinted on the printing substrate and fixed there.

A fluid developer containing at least toner and carrier fluid can in the process be used for inking the charge images. A method for such an electrophoretic fluid development (electrographic development) in digital printing systems is e.g. known from W/2007/57387 (US 2008/279597 A1). In the process a carrier fluid containing silicon oil with toner dispersed within is used as a fluid developer.

In the case of the printing device in accordance with WO2007/57387, a loading station, an element for image-wise exposure (character generator), a developer station for the development of the charge images with toner to toner images, a transfer station for reprinting of the toner images on a printing substrate and an element for cleaning of the photo conductor drum after reprinting are arranged along a charge image carrier. The toner images are fed to the printing substrate by the charge image carrier via the transfer station and are reprinted on the printing substrate. For this purpose a transfer roller or a transfer belt is used, the transfer roller or transfer belt taking the toner images e.g. embedded in carrier fluid in the case of the use of a fluid developer and feeding them to the printing substrate. In the reprinting station the toner images are reprinted on the printing substrate and are then fixed there under pressure and using an electric field.

The fixing of the toner images on the printing substrate takes place in a fixing station which is arranged after the transfer station on the printing substrate. In the process the fixing can take place by heat and pressure. Heat is supplied to the printing substrate, through which the toner of the toner images is melted on, in order to coalesce closely to the printing substrate. Heated fixing rollers or radiant heaters can be employed for the supply of heat, the fixing roller or radiant heaters melting the toner images with heat and pressure or radiant heat.

From U.S. Pat. No. 4,538,899 (ED 3406290) in addition it is known to employ a carrier fluid in the case of the use of fluid developers for the fixing of the toner images, the carrier fluid being able 10 be oxidized. The toner images are transferred with the carrier fluid to the printing substrate. There the carrier fluid is evaporated, wherein the toner images are fixed on the printing substrate by the evaporated carrier fluid.

### SUMMARY

It is an object to specify an arrangement for the fixing of printed images in which case the printed images are inked by a color medium, such as e.g. toner, and the inked printed images can be fixed on the printing substrate without the use of heat.

In a system for fixing printed images inked with a color medium on a printing substrate, a printing device supplies the printed images at a transfer point. In front of the transfer point, an application unit adjacent to the printing substrate applies a fluid film on a side of the printed substrate which receives the printed images after the application of the fluid film. The fluid film has a viscosity such that the color medium of the printed images migrates to a surface of the fluid film and remains adhered there. A drying unit after the transfer point dries the fluid film.

### BRIEF DESCRIPTION OF THE DRAWINGS

FIG. 1 shows a principle representation of an electrographic printing device with two printing mechanisms; and

FIG. 2 shows a transfer station of an electrographic printing device with representation of the transition of the printed images from a transfer roller to the printing substrate.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The fixing arrangement exhibits an application unit in front of the transfer station which is provided adjacent to the printing substrate and which applies a film from a viscous fluid on the side of the printing substrate to receive the printed images, in which said printing substrate the printed images are subsequently embedded. The color medium migrates to the film of fluid and remains adhered there on the surface. After a drying of the fluid with the printed images the printed images are firmly bonded to the printing substrate.

In the following explanation of the preferred embodiment this viscous fluid is to be named as fixing fluid.

With this the properties of the toner or of the color particle are no longer influential for the fixing of e.g. printed images comprised of toner as the color medium, since the fixing fluid applied to the printing substrate prior to the printing process will be used for fixing. This has the advantage that the transfer efficiency of the toner on the printing substrate can be improved. The toner then no longer has to be optimized to its melting properties, but rather only to its charging properties.

The color particles can be toner particles in an electrographic process, wherein fluid toner or dry toner can be used. The color particles can also be color particles dissolved in a fluid in an offset process. The particle size can be selected preferably in the range from 0.1 to 10 μm. However, in the following toner will be employed as the color medium for the explanation of the preferred embodiment.

The application unit can in simple fashion exhibit two application rollers, between which the printing substrate can be fed through. At least one of the application rollers can apply the fixing fluid to the printing substrate. In order to uniformly distribute the fixing fluid over the printing substrate and apply the fixing fluid in fixed height, a squeegee can be arranged at the output of the application rollers on the side of the printing substrate provided with the fixing fluid. The squeegee can in the process cooperate with a counter bearing on the other side of the printing substrate.

An inkjet printing system can be used as an application unit as another embodiment of the invention. This embodiment has the advantage that the fixing fluid can only be applied in the regions of the printing substrate that are to be printed. For offset printing methods a Flexo printing mechanism can be used as an application unit, which likewise applies the fixing fluid only on regions of the printing substrate which are to be printed,

Emulsion paint or ultra-violet hardening lacquer can be provided as a fixing fluid. Or a material can be used as is employed as a conventional paper coating. Additionally the fixing fluid that is used can contain particles which influence the surface roughness in order to design the surface impression of the printed area. In addition the fixing fluid can contain dyes in order to influence the color of the printing substrate.

In order to prevent an oxidation of the fixing fluid into the printing substrate or to prevent a retransfer of fixing fluid into a following printing mechanism of a printing device with several printing mechanisms, it is expedient to select the viscosity of the fixing fluid >1000 mPa*s.

In advantageous manner the preferred embodiment can in the case of an electrographic printing or copying device be employed for the fixing of the toner images reprinted on the printing substrate. In the case of such a printing device charge images of the images to be printed are produced on a charge image carrier, the images being developed in a developer station to toner images, wherein the toner images are reprinted in a transfer station on the printing substrate. If the transfer station exhibits a transfer roller pair, between the pair which the printing substrate with the fixing fluid is fed through, with the help of an electric voltage existing between the transfer rollers the charged toner in the fixing fluid can be drawn on the printing substrate. If the toner images are embedded in a carrier fluid, the toner in the transfer station migrates from the carrier fluid into the surface of the fixing fluid. This operation is supported if the viscosity of the carrier fluid is selected lower in comparison to the viscosity of the fixing fluid.

It is advantageous if the properties of the carrier fluid and the fixing fluid are selected in such a way that they can form a chemical compound. Then the mixture of toner and carrier fluid is bound even better to the printing substrate. The properties are in addition set in such a way that the lowest possible cohesion to the surface of a transfer roller of the transfer station exists and the coating remains as completely as possible on the printing substrate and does not partially pass over onto the transfer roller.

Additionally the possibility exists of applying a product on the printing substrate after the printing mechanisms of the printing device which forms a chemical compound with the printing substrate and which seals the printed image.

A series of advantages arise from the use of the preferred embodiment in the case of a printing device:
If paper is used as a printing substrate, lighter paper can be used since prior to the reprinting in a first step a coating is applied. As a result paper can be economized.
A simpler toner can be used, since one does not have to take into consideration the melting properties of the toner.
A drying of the fixing fluid after the transfer station can be carried out with Fess energy, since the toner does not have to be melted. With this the web travel properties are improved and the shrinkage of the printing substrate is reduced.
A finishing effect can be achieved through the applied fixing fluid. An enameling or a matte or glossy surface coating can be produced on the printing substrate.

The preferred embodiment will be explained more closely with the help of an exemplary embodiment which is shown in the figures. The figures show the following:

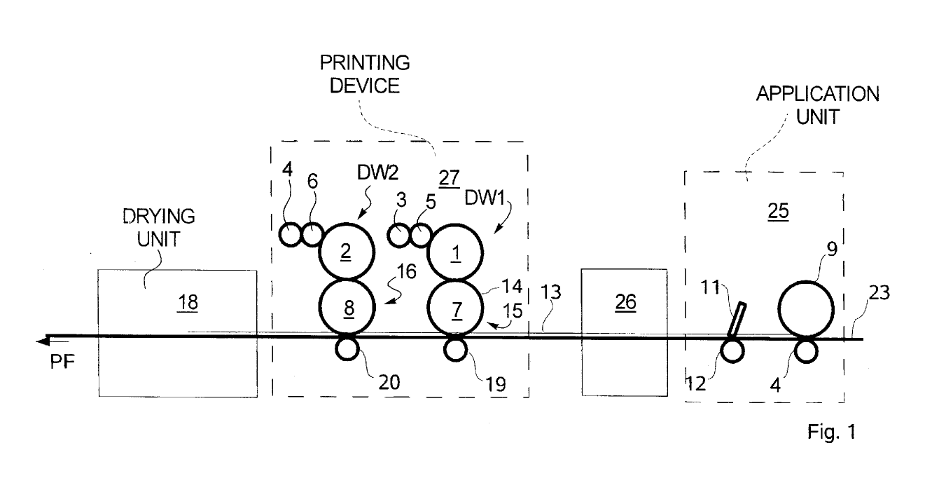

In FIG. 1 an electrographic printing device 27 is shown with two printing mechanisms DW1, DW2. From each printing mechanism DW1, DW2 a rotating photoconductor drum 1, 2 is shown as a charge image carrier, to which is to be fed a film e.g. from fluid developers. The fluid developer is fed by a raster roller 3, 4 of a developer roller 5, 6, which for the development of charge images on the photoconductor drum 1, 2 goes past the fluid developer on the photoconductor drum 1, 2. In dependency on the charge images on the photoconductor drum 1, 2 toner migrates from the fluid developer rollers 5, 6 onto the photoconductor drum 1, 2 and inks the charge images to toner images. Hence a fluid film comprised of carrier fluid and toner from the raster roller 3, 4 over the developer roller 5, 6 to the photoconductor drum 1, 2. The toner images migrate from the photoconductor drum 1, 2 to a transfer station 15, 16, the transfer station in principle being represented by a transfer roller 7, 8 and a counter-pressure roller 19, 20. A printing substrate 23 is transported in the direction of the arrow PR through the transfer station 15, 16 and in the process is pressed by the counter-pressure roller 19, 20 on the transfer roller 7, 8. From the photoconductor drum 1, 2 to the printing substrate 23 a film is comprised of carrier fluid, in which the toner images are embedded. The transition of the toner images from the transfer roller 7, 8 to the printing substrate 23 can be supported by an electrical voltage applied between the transfer rollers 7, 8 and the counter-pressure rollers 19, 20.

After the reprinting of the toner images on the printing substrate 23 the toner images have to be fixed on the printing substrate 23. For this purpose, in accordance with the preferred embodiment an application unit 25 is used which is arranged in front of the printing device 27 viewed in the transportation direction of the printing substrate 23. The application unit 25 exhibits an application roller 9 with counter-pressure roller 4 with which, in the case of the exemplary embodiment a film from a viscous fluid, the fixing fluid 13, is applied to the printing substrate 23 only with the application roller 9. In order to distribute the fixing fluid 13 applied on the printing substrate 23 uniformly on the printing substrate 23 a squeegee 11 with a counter bearing 12 is provided after the application roller 9. With the squeegee 11 the coating density in fixing fluid 13 is determined and in addition the fixing fluid 13 is uniformly distributed. Hence a uniform film of fixing fluid 13 is arranged on the printing substrate 23 after the application unit 25, the film being able to be supplied to the printing device 27.

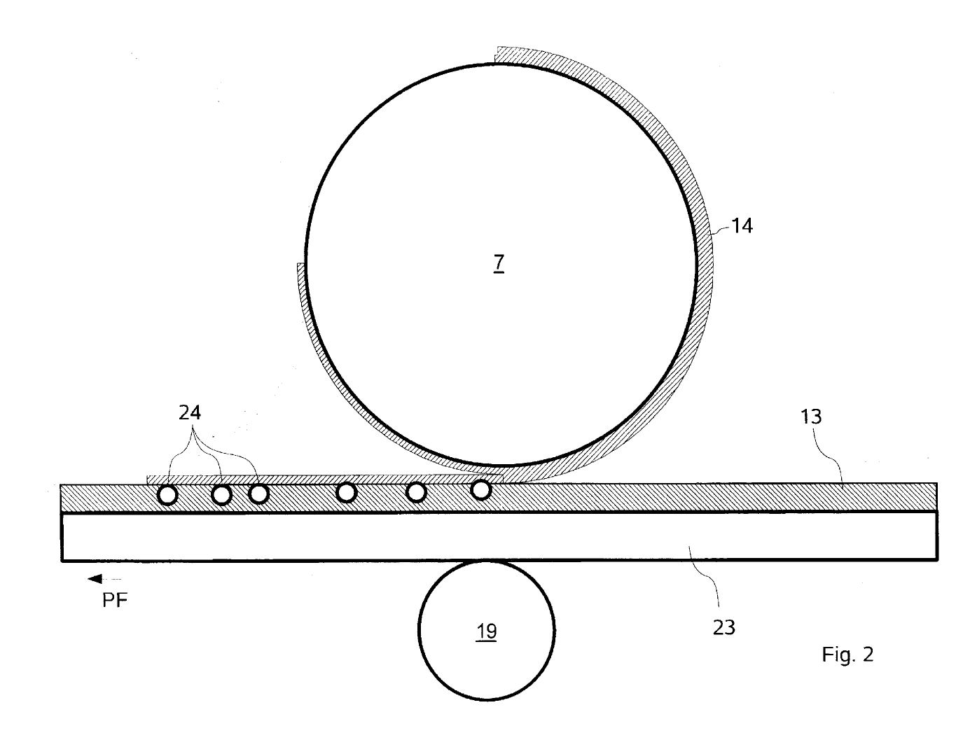

In the printing device 27 toner images are reprinted on the printing substrate 23 in the printing mechanisms DW1, DW2. FIG. 2 shows this step in principle. A coating 14 of carrier fluid with the embedded toner images is transported to the printing substrate 23 by the transfer roller 7. The fixing fluid 13 is arranged on the printing substrate 23. At the transfer point the coating 14 splits, under the influence of an electric field existing between the transfer roller 7, and counter-pressure roller 19, the toner images migrate in a partial coating in carrier fluid 14 to the fixing fluid 13, a remnant/residue in carrier fluid remaining on the transfer roller 7 and can be cleaned off from there. At the transfer point toner particles 24 migrate from the coating to the fixing fluid 13. If the viscosity of the fixing fluid 13 is great in comparison to that of the carrier fluid in the coating 14 the toner migrates electrophoretically through the layer 14 and into the fixing fluid 13 and remains adhered there in the upper region. In the process a retro-reaction of the fixing fluid 13 on the transfer roller 7 is prevented.

After the toner images have migrated to the fixing fluid 13, the fixing fluid 13 can be dried by a drying unit 18 arranged behind the transfer station 15, 16. This can take place by the supply of heat or in the case that an ultra-violet hardening lacquer is used as a fixing fluid 13, by means of ultraviolet radiation. In the process the toner is not melted, since the toner is embedded in the fixing fluid 13 and is firmly bonded with said fixing fluid. The fixing fluid 13 can in addition be influenced in such a way that the fixing fluid 13 with the printed images after the drying in the drying unit 18 exhibits additional creative properties. For example dyes can be admixed to the fixing fluid 13 and with this the color of the printing substrate 23 can be altered. Or particles can be admixed to the fixing fluid 13 in order to set the roughness of the surface of the printing substrate 23 or to produce a matte or glossy surface impression.

The preferred embodiment has been described using the example of an inking with fluid developers in the case of an electrographic printing device. The preferred embodiment is however not restricted to this; it can also be used with dry toner or with color particles dissolved in fluid. Additionally instead of the photoconductor drums 1, 2 and transfer rollers 7, 8 belts can also be used.

Instead of the application roller 9 jets can also be employed for the application of the fixing fluid 13. In the case of an additional embodiment of the invention an inkjet printing system can be used as an application unit 25. This embodiment has the advantage that the fixing fluid 13 can be applied only in the regions of the printing substrate 23 which are to be printed. For offset printing methods a Flexo printing mechanism can be used as an application unit 25, the Flexo printing mechanism likewise applying the fixing fluid 13 only on regions of the printing substrate 23 that are to be printed.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. A system for fixing of printed images inked with a color medium on a printing substrate, comprising:
a printing device which applies the printed images at a transfer point on the printing substrate;
in front of the transfer point viewed in a direction of transport of the printing substrate an application unit adjacent to the printing substrate which applies a fluid film on a side of the printing substrate which receives the printed images after the application of the fluid film;
the fluid film having a viscosity such that the color medium of the printed images migrates to a surface of the fluid film and remains adhered there; and
a drying unit after the transfer point which dries the fluid film.

2. The system according to claim 1 in which the application unit has an application roller and a counter pressure roller between which the printing substrate is fed through, wherein the application roller applies the fluid film to the printing substrate.

3. The system according to claim 2, in which at an output of the application roller on the side of the printing substrate provided with the fluid film a squeegee is arranged which distributes the fluid film uniformly over the printing substrate.

4. The system according to claim 1 in which the application unit comprises an inkjet printing system which applies the fluid film only in regions of the printing substrate in which printed images are applied.

5. The system according to claim 1 in which the fluid film is comprised of an emulsion paint.

6. The system according to claim 1 in which the fluid film is comprised of ultra-violet hardening lacquer.

7. The system according to claim 1 in which the viscosity of the fluid is >1000 mPa*s.

8. The system according to claim 1 in which the fluid film has particles influencing a printed surface at the printing substrate.

9. The system according to claim 1 in which a drying unit is provided after the printing device adjacent to the printing substrate which dries the fluid film supplied by the application unit.

10. The system according to claim 1 in which the color medium exhibits color particles whose size ranges from 0.1 μm to 10 μm.

11. The system of claim 1 wherein the printing device comprises an electrographic printing or copying device.

12. An electrographic printing or copying system, comprising:
a printing device having a transfer station at which toner images are transferred at a transfer point onto a printing substrate, a developer station which applies toner for electrostatic toner images onto a charge image carrier transfer roller, and wherein said transfer station comprises said transfer roller and a counter-pressure roller between which the printing substrate is fed through, and wherein an electrical voltage is provided to cause toner to migrate to a fluid film applied on the printing substrate;
in front of said transfer point in a direction of transport of the printing substrate an application unit adjacent to the printing substrate which supplies said fluid film on a side of the printing substrate which receives the toner images after the application of the fluid film;
said fluid film having a viscosity such a color medium of the toner images migrates to a surface of the fluid film and remains adhered there; and
a drying unit after the transfer point which dries the fluid film.

13. The electrographic printing or copying device according to claim 12 in which the toner images are embedded in a carrier fluid in such a way that the toner in the transfer station migrates from the carrier fluid to the fluid film, and wherein a viscosity of the carrier fluid is lower in comparison to the viscosity of the fluid film.

14. The electrographic printing or copying device according to claim 12 in which properties of the carrier fluid and of the fluid film are selected such that they form a chemical compound.

15. A system for fixing of printed images inked with a color medium on a printing substrate, comprising:
a printing device which applies the printed images at a transfer point on the printing substrate;
in front of the transfer point viewed in a direction of transport of the printing substrate an application unit adjacent to the printing substrate which applies a fluid film on a side of the printing substrate which receives the printed images after the application of the fluid film;
the color medium of the printed images being provided at a surface of the fluid film; and
a drying unit after the transfer point which dries the fluid film.
